(19) United States
(12) Patent Application Publication
(10) Pub. No.: US 2017/0021986 A1
(43) Pub. Date: Jan. 26, 2017

(54) Packaging System and Manufacturing Thereof

(71) Applicants: Robert Bosch Tool Corporation, Broadview, IL (US); Robert Bosch Gmbh, Stuttgart (DE)

(72) Inventor: Daniel Teicher, Langendorf (CH)

(21) Appl. No.: 15/217,673

(22) Filed: Jul. 22, 2016

Related U.S. Application Data
(60) Provisional application No. 62/195,880, filed on Jul. 23, 2015.

(51) Int. Cl. B65D 75/36; E05B 73/00; B65D 85/00; B65D 75/56; B25H 3/00

(52) U.S. Cl. CPC B65D 75/36; B65D 75/566; B25H 3/003; B65D 85/70; E05B 73/0017

(57) ABSTRACT

A packaging assembly includes first and second subassemblies and a panel. A product is suspended over the panel and is disposed within a container portion formed within the first subassembly. A stiffening channel is provided on the second subassembly. A blotter card is placed on top of the first subassembly.

### TECHNICAL FIELD

The disclosure relates generally to packaging systems and particularly to packaging systems and method for tool accessories.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of the disclosure related to packaging systems and method for tool accessories. The tool accessory packaging system comprises a first subassembly, a second subassembly including a thermoformed film and a container portion, a tool accessory is disposed within the container portion, and a support member forms a front side, a back side connected to the front side along a fold line, and a left edge and right edge are folded in one direction along a fold line, wherein one of the first and second subassembly is attached to the support member. In one embodiment, the second subassembly further comprises a channel portion extends around the tool accessory. The thermoformed film is selected from a group consisting of polyethylene terephthalate (PET), polypropylene (PP), polyvinyl chloride (PVC), polystyrene (PS), special polyethylene terephthalate (SPET), and alternative polyethylene terephthalate (APET). The tool accessory packaging system further comprises an anti-thief device secured to one of the first subassembly, second subassembly, or the support member wherein the anti-thief device is selected from a group consisting of a security tag, a near field communication (NFC) tag, a RFID tag, a global positioning tag, an identification tag, and an electronic tag. The support member is selected from a group consisting of cardboard, paperboard, corrugated fiberboard, paper fiberboard, non-recycle materials, and cycle materials. In one embodiment, the tool accessory is secured to the first subassembly. A second tool accessory differs from the tool accessory is secured to the first assembly. The tool accessory is selected from a group consisting of a nut setter, a saw blade, a jig saw blade, a rebar cutter, a hammer steel, a hammer drill bit, a planar blade, a diamond abrasive blade, a screwdriver bit, a router bit, a reciprocating saw blade, a cutting accessory, a scraping or removal accessory, spark plugs, and a drill bit.

In another embodiment, the second tool accessory differs from the tool accessory is secured to the second subassembly.

According another exemplary embodiment of the disclosure, a tool accessory packaging system includes a subassembly including a thermoformed film and a container portion, a tool accessory is disposed within the container portion, and a support member forms a front side, a back side connected to the front side along a fold line, and a left edge and right edge are folded in one direction along a fold line, wherein the subassembly is secured to the support member and the tool accessory.

In one embodiment, the subassembly comprises a channel portion extends around the tool accessory. The thermoformed film is selected from a group consisting of polyethylene terephthalate (PET), polypropylene (PP), polyvinyl chloride (PVC), polystyrene (PS), special polyethylene terephthalate (SPET), and alternative polyethylene terephthalate (APET).

In another embodiment, the tool accessory packaging system further comprises an anti-thief device secured to one of the subassembly or the support member. The anti-thief device is selected from a group consisting of a security tag, a near field communication (NFC) tag, a RFID tag, a global positioning tag, an identification tag, and an electronic tag.

In yet another embodiment, the support member is selected from a group consisting of cardboard, paperboard, corrugated fiberboard, paper fiberboard, non-recycle materials, and cycle materials.

The tool accessory is selected from a group consisting of a nut setter, a saw blade, a jig saw blade, a rebar cutter, a hammer steel, a hammer drill bit, a planar blade, a diamond abrasive blade, a screwdriver bit, a router bit, a reciprocating saw blade, a cutting accessory, a scraping or removal accessory, spark plugs, and a drill bit.

### BRIEF DESCRIPTION OF THE DRAWINGS

FIG. 1A is a perspective view of a packaging assembly in accordance with an embodiment;

FIG. 1B is a perspective view of another embodiment of a packaging assembly according to the disclosure;

FIG. 2 is a cross-sectional view of the packaging assembly of FIG. 1;

FIG. 3 is a schematic view of a heating station for heating the film of the packaging assembly of FIG. 1;

FIG. 4 is a schematic view of a thermoforming station configured to use vacuum pressure to thermoform the film of FIG. 2 on a product of the packaging assembly of FIG. 1;

FIG. 5 is a schematic view of the thermoforming station of FIG. 4 after vacuum pressure has been used to draw the heated film down over the products;

FIG. 6 is a schematic view of the thermoformed film and product of FIG. 5 being singulated to form first packaging subassembly;

FIG. 7 is a top view of a die cut of a panel;

FIG. 8 depicts a perspective view of the panel of FIG. 7;

FIG. 9 is a schematic view of the panel of the packaging assembly of FIG. 1 with an anti-theft device attached thereto; and

FIG. 10 is a schematic view of the panel of FIG. 7 with a cover attached over the anti-theft device to form a second packaging subassembly.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one of ordinary skill in the art to which this disclosure pertains.

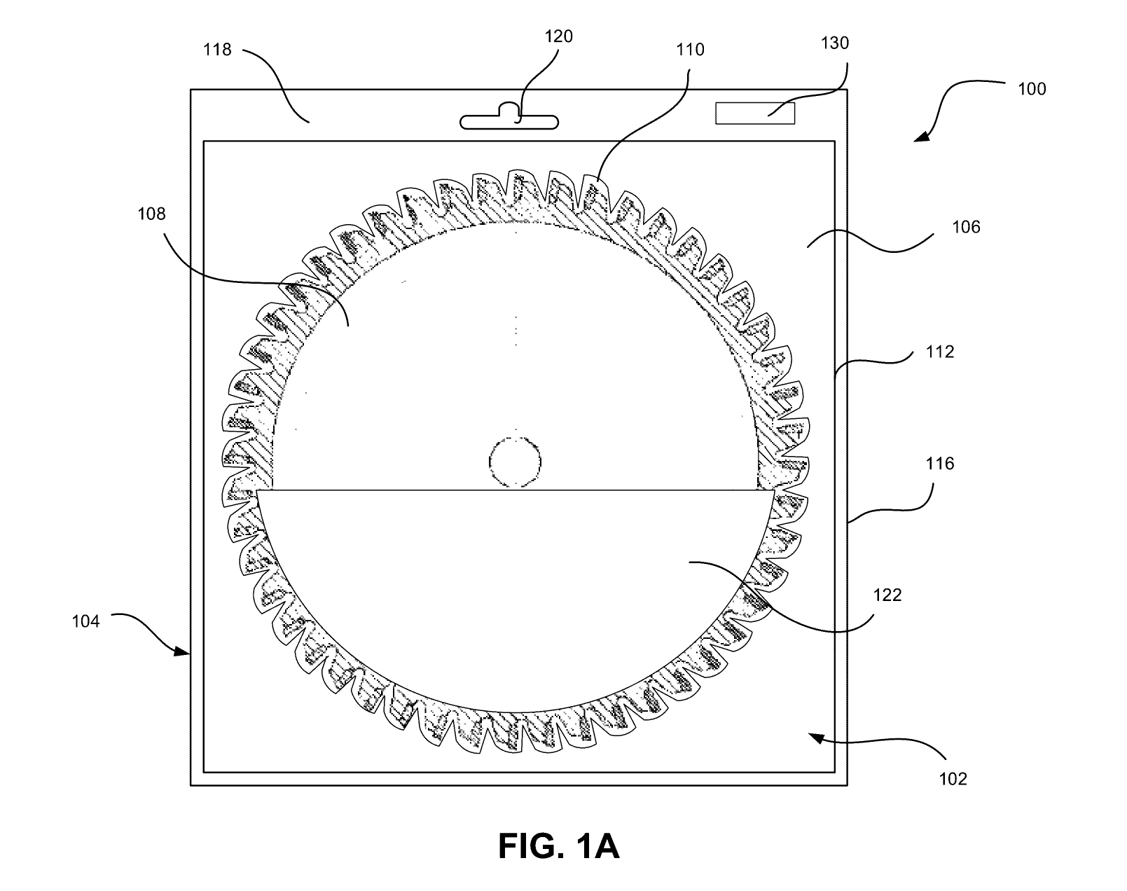

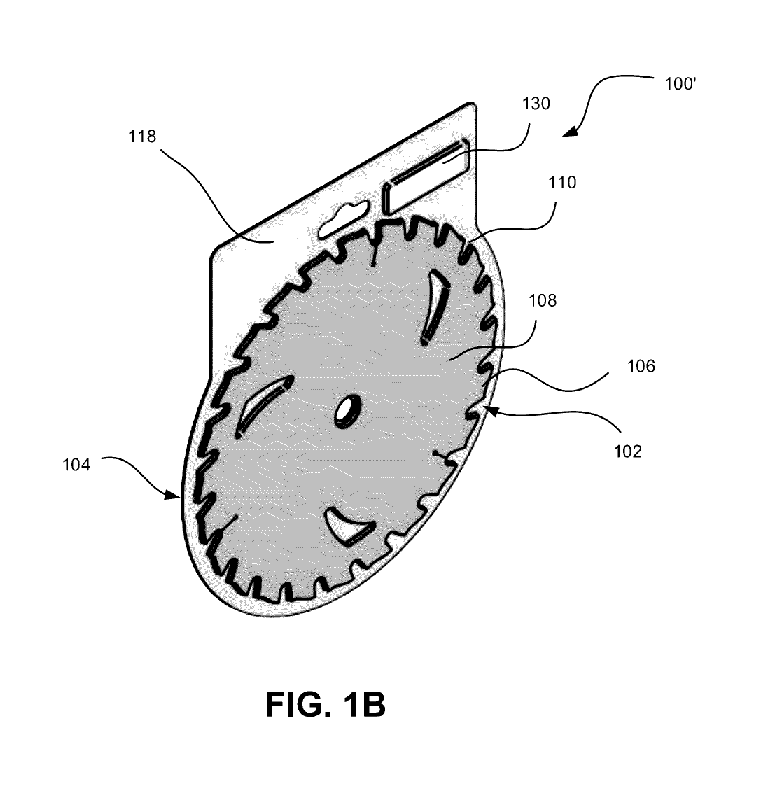

The disclosure is directed to a packaging system or a packaging assembly 100 for a product, such as a tool, accessory tool, part, and the like, and a method of packaging such products. An exemplary embodiment of the packaging assembly 100 in accordance with the disclosure is depicted in FIG. 1A. The packaging assembly 100 includes a first subassembly 102 and a second subassembly 104. A thermoformed film 106 may be formed on either the first subassembly 102, the second subassembly 104, or combination of both subassemblies 102, 104. A product 108 is disposed on the first subassembly 102. In some embodiments, the product 108 may be disposed on the second subassembly 104 instead. More than one product may be disposed on the same subassembly or both subassemblies, depending on application. In yet another embodiment, different products may be disposed on both subassemblies 102, 104. For example, an 8 inches circular saw blade is disposed on the first subassemblies 102 and a 10 inches circular saw blade or a non-circular saw blade is disposed on the second subassemblies 104. The thermoformed film 106 formed from a thermoformed sheet comprises a container portion 110 and a channel portion 112. In some embodiment, the channel portion 112 may be optional and therefore is not required in the packaging system 100. As illustrated, the container portion 110 for retaining the product 102 is provided on the first subassembly 102. The channel portion 112 extends around the product 108 and adjacent to an edge 116 of the first subassembly 102. The thermoformed film 106 covered the first subassembly 102 and the product 108 may either terminate at the edge 116 of the first subassembly 102 or continue to cover the edge 116 of the first subassembly 102 and terminate at the second subassembly 104. At least a portion of the second subassembly 104 is covered with the thermoformed film 106. In some embodiments, the second subassembly 104 may be completely covered with the thermoformed film 106. In one embodiment, a separate film may be thermoformed on either side of the subassembly 104, 106 comprises an optional container portion and optional channel portion. The second thermoformed film is then attached to the first thermoformed film 106 by any form of conventional attachment techniques to further protect the package system 100 from wear and tear from shipping handling or the like.

The film 106 after thermoformed can be rigid semi-rigid. The thermoformed film 106 can be clear or transparent, or it can be colored. For example, the thermoformed film 106 can be formed from polyethylene terephthalate (PET), polypropylene (PP), polyvinyl chloride (PVC), polystyrene (PS), special polyethylene terephthalate (SPET), alternative polyethylene terephthalate (APET), laminated combination of thermoplastic and non-thermoplastic materials or other suitable thermoplastic and non-thermoplastic materials. The thermoformed film 106 can be in a form of a single layer structure or a multi-layer structure.

As explained below, the container portion 110 is formed by using the product 108 as a mold once place on the subassembly 104 during the thermoforming process. Therefore, the container portion 110 closely conforms to the contours and outer shape of the product 108. The exact shape depends on the profile of product. In the embodiment of FIG. 1A, the product 108 comprises a circular saw blade. Examples of other products that can be packaged in the packaging assembly using the methods described herein include, but are not limited to, a nut setter, a saw blade, a jig saw blade, a rebar cutter, a hammer steel, a hammer drill bit, a planar blade, a diamond abrasive blade, a screwdriver bit, a router bit, a reciprocating saw blade, a cutting accessory, a scraping or removal accessory, spark plugs, a drill bit, or other known power tool and non-power tool accessories.

The second subassembly 104 includes a support member 118 that provides a structure for attaching the first subassembly 102 and that enables the packaging assembly 100 to be easily transported, stored, and displayed, e.g., by hanging or standing, as a unit. In another embodiment, an intermediate support member, other than the support member 118, may be provided in between either the support member 118 and the first subassembly 102, the support member 118 and the second subassembly 104. In the embodiment of FIG. 1, the support member 118 comprises a panel having a generally planar configuration. The support member 118 can be formed from a rigid film, a semi-rigid film, or any suitable materials including rigidity. The support member 118 can be clear or transparent, or it can be colored. For example, the support member 118 can be formed polyethylene terephthalate (PET), polypropylene (PP), polyvinyl chloride (PVC), polystyrene (PS), special polyethylene terephthalate (SPET), alternative polyethylene terephthalate (APET), laminated combination of thermoplastic and non-thermoplastic materials or any suitable thermoplastic and non-thermoplastic materials. The support member 118 can be formed of a single layer structure or a multi-layer structure. In alternative embodiments, the support member 118 may be formed of other materials, such as cardboard, paperboard, corrugated fiberboard, paper fiberboard, or any non-recycle and recycle materials that is rigid to transport the product 108 without damaging the product 108 and the packaging assembly 100.

The support member 118 is sized and shaped in a manner appropriate for the product 108 contained in the film 106 of the first subassembly 102. The size of the support member 118 is at least sufficient to provide a surface for attaching the film 106. In alternative embodiments, a support member 118 may be provided in configurations that are not planar, such as a box, cylinder, or other type of three-dimensional shape. In yet another embodiment, the support member 118 may be a stiffening channel configured to prevent edges or corners against bending. As illustrated in FIG. 1B, the support member 118 is sized and shaped in a formed of a circular blade.

Now return to FIG. 1A, a mounting member 120 for placing the packaging assembly 100 over an outwardly extending rod or hook is provided. The mounting member 120 may be formed by punching through at least one of the panel 118, the film 106, or combination of the panel 118 and the film 106. If the mounting member 120 is formed on the panel 118, the film 106 terminates adjacent and below the mounting member 120. Likewise, the support member 118 terminates adjacent and below the mounting member 120 if the mounting member is formed on the film 106 only. In alternative embodiments, the support member 118 or other type of support member may be provided with a feet or a base that enables the packaging assembly 100 to stand up right, e.g., for placement on a display shelf. The support member 118 may also include labels, markings, printed text, pictures, and the like for providing product information to consumers, such as weight, quantity, measurement, industry standard, logo, warning statement, model, part number, icon, or other information. In alternate embodiment, the mounting member 120 is formed on a separate panel and then later attaches the panel to the packaging assembly 100 by any conventional known attachment technologies. Although one mounting member 120 is shown, more than one mounting member 120 may be formed on the packaging assembly 100.

The support member 118 may be provided with an optional anti-theft device 130. The anti-theft device 130 can be a security tag, such as a near field communication (NFC) tag, a RFID tag, a global positioning tag, an identification tag, an electronic tag, for example, or other known security device with and without a built-in tracking enabled software. An anti-theft device 130 may be secured to the support member 118 in any suitable manner and at any suitable location on the panel. In one embodiment, the anti-theft device 130 is attached to the support member 118 by a separate film that covers the anti-theft device and is adhered to the support member 118 around the device. The anti-theft device 130 can be left visible on the packaging assembly 100 to provide a visual theft deterrent, or the device 130 can be concealed on or in the packaging assembly to prevent removal.

A blotter card 122 is disposed on the first subassembly 102. The card 122 may be placed in front of the product 108. As shown, the lower portion of the product 108 is covered by the card 122. The card 122 may be a label card, a product marking, a printed text card, a picture card, and the like (not shown) for providing information to consumers, such as weight, quantity, measurement, industry standard, logo, warning statement, model, part number, icon, or other known information. The anti-thief device may be optionally attached to the blotter card 122 instead of to the panel 118.

FIG. 1B illustrates another exemplary embodiment of a packaging system 100′. The packaging system 100′ is similar to the packaging system 100 of FIG. 1A except the support member 118 is sized and shaped in a formed of a circular blade. Unlike from the packaging system 100 of FIG. 1A, the channel portion 112 is not required. As can be seen, the shape of the support member 118 is substantially conformed to the circular shape of the blade 108, corner is not required on a circular geometry. Therefore, channel portion 112 is therefore not required in this application.

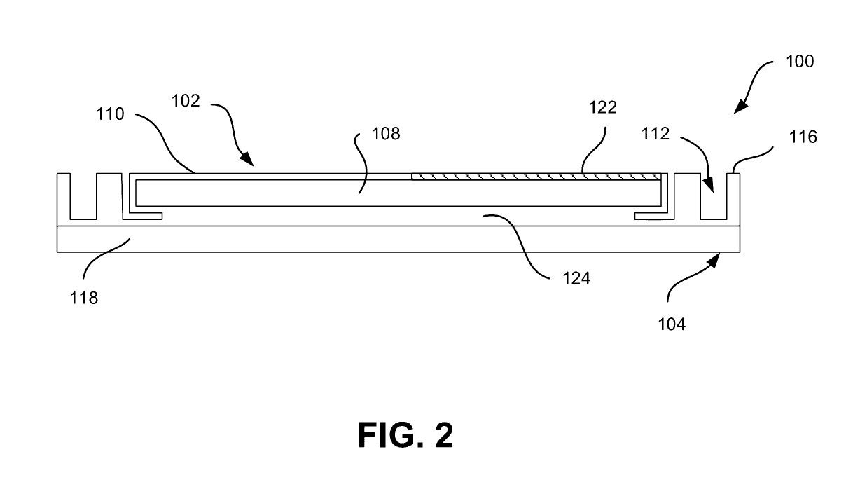

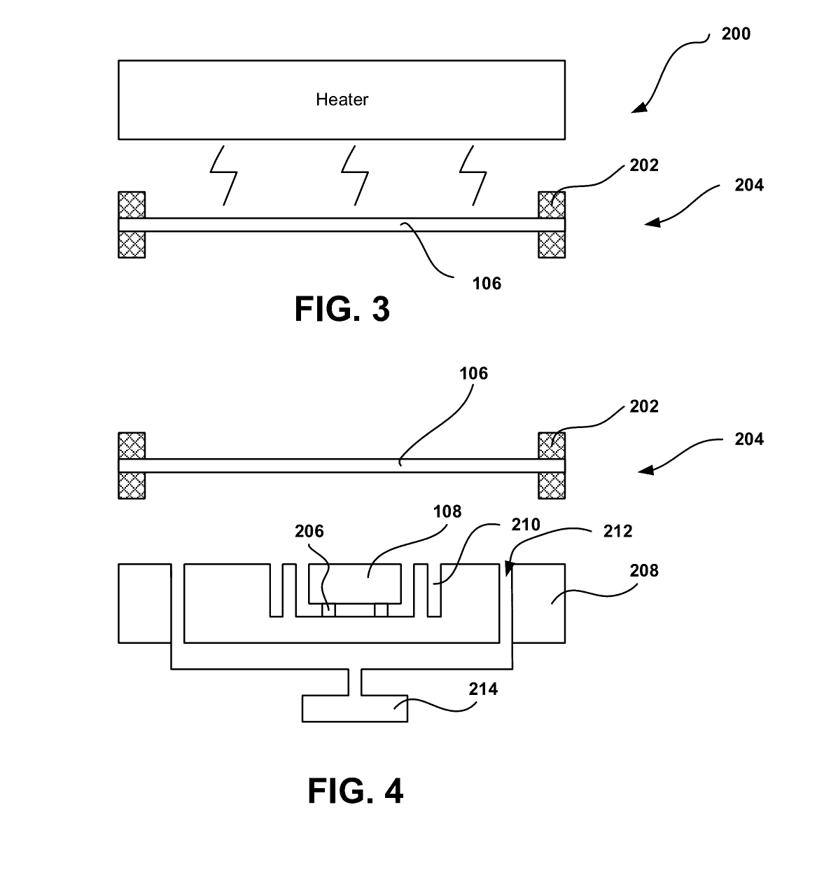

Now referring to FIG. 2, a cross-sectional view of the packaging assembly 100 is illustrated. The product 108 is disposed within the container portion 110 of the film 106. A gap 124 is formed within the container portion 110 by placing a fixture 206 (FIG. 3) between the product 108 and a vacuum-plate 208 (FIG. 3) during the process of packaging a product. The forming of gap 124 will be described below in greater details.

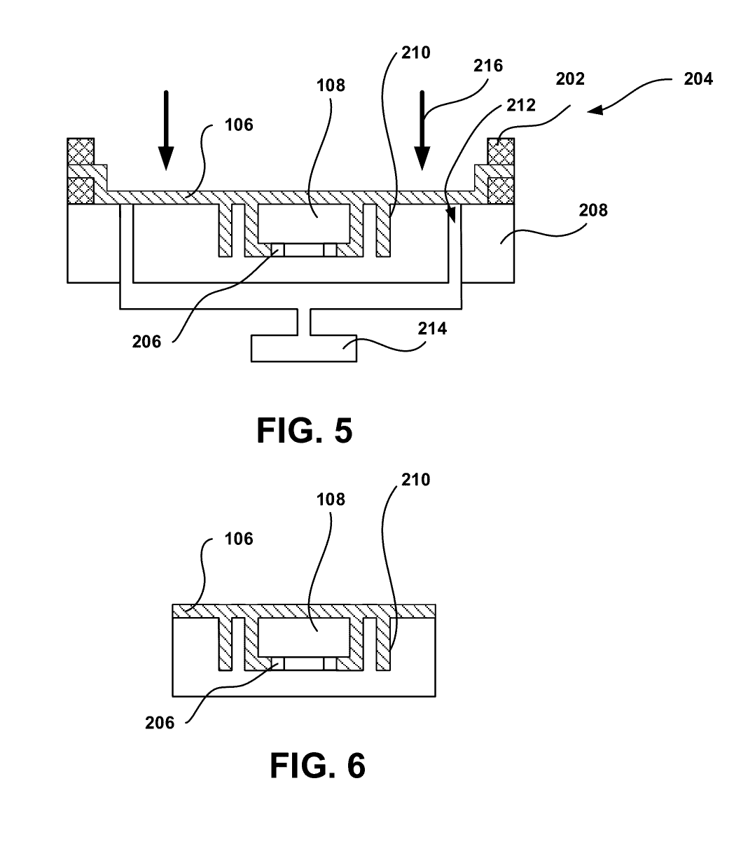

A schematic depiction of a process of packaging a product to form a packaging assembly 100, such as depicted in FIGS. 1 and 2, is depicted in FIGS. 3-10. As depicted in FIG. 3, the film 106 for the first subassembly 102 is exposed to a thermoforming temperature at a heating station 200, such as an oven. The forming temperature may be any suitable temperature for the type of material used for the film that is capable of causing the film to become pliable and capable of being stretched and deformed without tearing or breaking and that does not burn or blister the film.

The film 106 is clamped in a film frame assembly 202 at a thermoforming station 204 and stretched over a forming area of the thermoforming station 204 as depicted in FIG. 3. Meanwhile, at least one product 108 is moved into the thermoforming station 204 for engagement with the film 106 as part of the thermoforming process. In alternative embodiments, more or fewer products (including a single product) may be used in the thermoforming process at a time.

The product 108 may be supported, depending on the profile of the product, by a fixture such as a spacer 206 and spaced apart from a vacuum-plate 208 with a molded cavity 210 in the thermoforming station 124. If more than one product 108 moved into the thermoforming station 204, the products 108 may each be the same product although not necessarily. The vacuum-plate 208 may be a component of the thermoforming station 204 or may comprise a portion of a conveyor system, such as a belt that is fed through the thermoforming station 204. One or the other or both of the film frame assembly 202, the fixture 206, and the vacuum-plate 208 are configured to move until the film frame assembly 202 contacts the vacuum-plate 208 so that the film 106 can be brought into engagement with the product 108. The product 108 on the spacer 206 and the vacuum-plate 208 are used as a mold to shape the film 106 and form a container portion 110 in the film. In addition, the spacer 206 between the product 108 and the vacuum-plate 208 is used to form a gap 124 between the product 108 and the vacuum-plate 208. The molded cavity 210 of the vacuum-plate 208 is used to form a channel portion 112 of the film 106 during the thermoforming process. As illustrated in FIG. 4, the method of forming the mold defines a negative molded system. In alternate embodiments, the method of forming the mold such that the mold protrudes outwardly from the product 108 defines a positive molded system, as depicted in FIG. 11.

To thermoform the film 106, some type of pressure is used to cause the film to surround and closely conform to the product. In one embodiment, the thermoforming station 204 is configured to utilize vacuum pressure to cause the film 106 to be drawn around the product 108 and underneath an outer peripheral of the product 108 adjacent to the spacer 206 on the vacuum-plate 208. Vacuum pressure may be generated in any suitable manner. As an example, the film frame assembly 202 may be configured to form an air tight seal with the vacuum-plate 208. The vacuum-plate 208 may be provided with openings 212 that enable air to be drawn out of the vacuum chamber by a vacuum generator 214. As the air is drawn out of the vacuum chamber, the film 106 is drawn down toward the vacuum-plate 208 until the film 106 surrounds and closely conforms to the shape of the products 108 suspended over the spacer 206. The channel 112 conforms to the shape of the molded cavity 210 is also formed as the air is drawn out of the vacuum chamber. As an alternative to vacuum pressure, the thermoforming station may be configured to utilize other means of thermoforming the film using the products as the mold. For example, the thermoforming station may be configured to use pressure thermoforming or mechanical thermoforming techniques. In addition, the positions of the film and the product may be changed so that the product is supported above the film and the film is drawn up around the products.

After the film 106 has been shaped, the film 106 is allowed to cure around the products so that the film 106 can retain the thermoformed shape. The film 106 may be cured in place in the thermoforming station 204 or may be transported to a curing station (not shown) for curing. The film 106 may be cured in any suitable manner appropriate for the materials used. Examples of types of curing that may be used include radiant heating, cooling, forced air, microwave dryers and combinations of these types.

Before or after the film 106 has been cured, the thermoformed film 106 on the product 108 may be separated from the film frame assembly 202. If multiple products 108 are used during the thermoforming process, the products 108 may be singulated into individual subassemblies along die cutting lines 216 either between each product 108 using a die cutting machine (Not shown) or between the film frame assembly 202 after the film 106 is cured. The film 106 may be singulated in any suitable manner. Other suitable methods of die cutting process are sufficed such as using a saw, a laser, a strip knife blade, water jet, ultrasonic, or other known singulating process. As depicted in FIG. 6, a first packaging subassembly 102 is formed after the film 106 is singulated from another product or separated from the film frame assembly 202. The packaging subassembly 102 may include a single product 108, multiple stack products, or more than one product 108 such that the products are placed side by side. The first packaging subassembly 102 may then be attached to a second packaging subassembly 104.

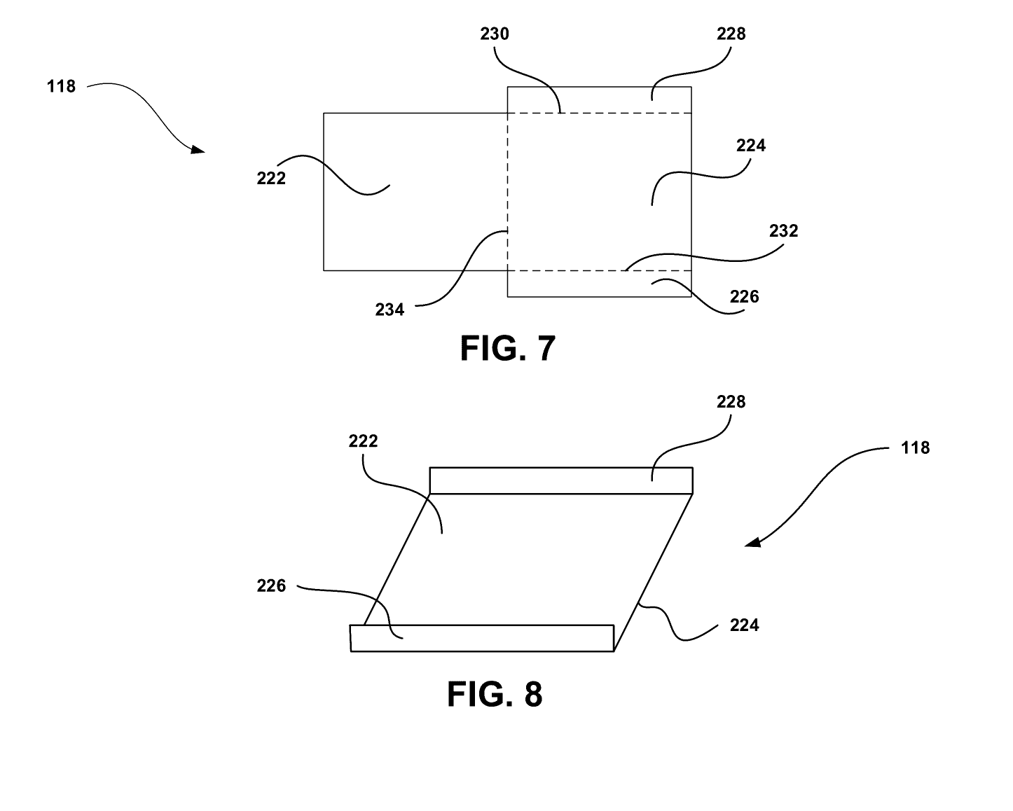

As shown in FIG. 7, the panel 118 comprises a front side 222 and a back side 224 connected to the front side 222 along a fold line 234. A left edge 226 is connected to the backside along a fold line 232 and a right edge 228 is connected to the backside along a fold line 230. In alternate embodiments, the left edge 226 is connected to the front side along a fold line, the right edge 228 is connected to the front side along a fold line.

The left edge 228 and the right edge 232 as shown in FIG. 8 are folded upward along the fold lines 228, 232. The front side 222 is folded toward the back side 224 along the fold line 234. In alternate embodiment, the folded sides may be applied to a panel that has no folding line between front side and backside. Once the panel 118 is assembled, one of the first or second packaging subassembly 102, 104 is attached to the panel 118.

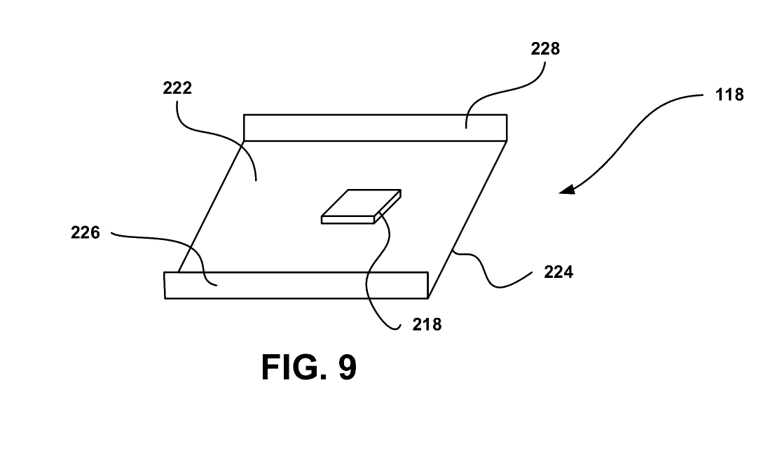

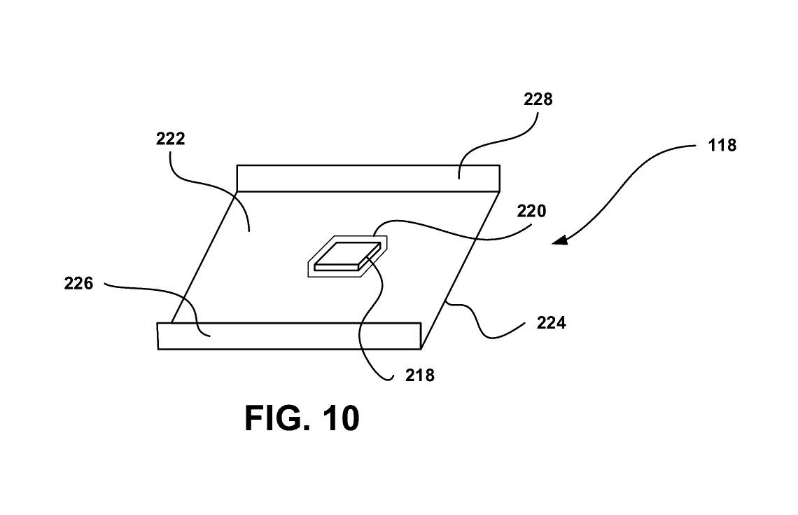

As depicted in FIG. 9, the second subassembly 104 comprises the panel 118. An anti-theft device 218 may be provided on the panel 118, as described above. The anti-theft device 218 may be attached to a surface of the panel 118, e.g., using adhesive or bonding. To protect the anti-theft device, a covering 220, such as a film, as illustrated in FIG. 10 is placed over the anti-theft device 218 and attached to the panel 118 around the anti-theft device. To encapsulate the anti-theft device 218, the film 220 may undergo a process to seal the circumferential surfaces of the film 220 and the panel 218 together and minimize the likelihood of neutralizing the anti-theft device 218. The film 220 may comprise a rigid plastic that is opaque or clear that is sufficiently sized to cover the anti-theft device and be attached to the panel. In alternative embodiments, other types of coverings for the anti-theft device may be used.

The first packaging subassembly 102 may be attached to the second packaging subassembly 104 before or after an anti-theft device 218 has been attached to the panel 118. Alternatively, the panel 118 may be attached to the outside of one of the first and second packaging subassemblies 102, 104 after the first and second packaging subassembly 104 are sealed together. Any suitable adhesive or may be used depending upon the materials used for tray and film. Alternatively, some type of heat and/or pressure type seal may be used to seal the subassemblies 102, 104.

In alternate embodiment, a blotter card 122 may be placed on the product before thermoforming the foil 106 to the product and therefore adhesive is not required to fixedly attach the card to the product. In yet another embodiment, the blotter card 122 may be a label card, a product marking, a printed text card, a picture card, and the like (not shown) for providing information to consumers, such as weight, quantity, measurement, industry standard, logo, warning statement, model, part number, icon, or other known information.

The above described packaging systems and methods can save time and reduce costs in the packaging process. In addition, numerous modifications of the above-described processes and systems are possible and fall within the scope of the present disclosure. For example, although many of the steps describe above were described as being performed separately or at separate stations, a person of ordinary skill in the art would understand that certain steps may be combined or performed simultaneously.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A tool accessory packaging system comprising:
a first subassembly;
a second subassembly including a thermoformed film and a container portion;
a tool accessory is disposed within the container portion; and
a support member forms a front side, a back side connected to the front side along a fold line, and a left edge and right edge are folded in one direction along a fold line;
wherein one of the first and second subassembly is attached to the support member.

2. The tool accessory packaging system of claim 1 wherein the second subassembly further comprising a channel portion extends around the tool accessory.

3. The tool accessory packaging system of claim 2 wherein the thermoformed film is selected from a group consisting of polyethylene terephthalate (PET), polypropylene (PP), polyvinyl chloride (PVC), polystyrene (PS), special polyethylene terephthalate (SPET), and alternative polyethylene terephthalate (APET).

4. The tool accessory packaging system of claim 1 further comprising:
an anti-thief device secured to one of the first subassembly, second subassembly, or the support member.

5. The tool accessory packaging system of claim 4 wherein the anti-thief device is selected from a group consisting of a security tag, a near field communication (NFC) tag, a RFID tag, a global positioning tag, an identification tag, and an electronic tag.

6. The tool accessory packaging system of claim 1 wherein the support member is selected from a group consisting of cardboard, paperboard, corrugated fiberboard, paper fiberboard, non-recycle materials, and cycle materials.

7. The tool accessory packaging system of claim 1 wherein the tool accessory is secured to the first subassembly.

8. The tool accessory packaging system of claim 7 wherein a second tool accessory is secured to the first assembly.

9. The tool accessory packaging system of claim 7 wherein the second tool accessory differs from the tool accessory.

10. The tool accessory packaging system of claim 9 wherein the tool accessory is selected from a group consisting of a nut setter, a saw blade, a jig saw blade, a rebar cutter, a hammer steel, a hammer drill bit, a planar blade, a diamond abrasive blade, a screwdriver bit, a router bit, a reciprocating saw blade, a cutting accessory, a scraping or removal accessory, spark plugs, and a drill bit.

11. The tool accessory packaging system of claim 7 wherein a second tool accessory is secured to the second subassembly.

12. The tool accessory packaging system of claim 11 wherein the second tool accessory differs from the tool accessory.

13. A tool accessory packaging system comprising:
a subassembly including a thermoformed film and a container portion;
a tool accessory is disposed within the container portion; and
a support member forms a front side, a back side connected to the front side along a fold line, and a left edge and right edge are folded in one direction along a fold line;
wherein the subassembly is secured to the support member and the tool accessory.

14. The tool accessory packaging system of claim 13 wherein the subassembly further comprising a channel portion extends around the tool accessory.

15. The tool accessory packaging system of claim 14 wherein the thermoformed film is selected from a group consisting of polyethylene terephthalate (PET), polypropylene (PP), polyvinyl chloride (PVC), polystyrene (PS), special polyethylene terephthalate (SPET), and alternative polyethylene terephthalate (APET).

16. The tool accessory packaging system of claim 13 further comprising:
an anti-thief device secured to one of the subassembly or the support member.

17. The tool accessory packaging system of claim 16 wherein the anti-thief device is selected from a group consisting of a security tag, a near field communication (NFC) tag, a RFID tag, a global positioning tag, an identification tag, and an electronic tag.

18. The tool accessory packaging system of claim 13 wherein the support member is selected from a group consisting of cardboard, paperboard, corrugated fiberboard, paper fiberboard, non-recycle materials, and cycle materials.

19. The tool accessory packaging system of claim 13 wherein the tool accessory is selected from a group consisting of a nut setter, a saw blade, a jig saw blade, a rebar cutter, a hammer steel, a hammer drill bit, a planar blade, a diamond abrasive blade, a screwdriver bit, a router bit, a reciprocating saw blade, a cutting accessory, a scraping or removal accessory, spark plugs, and a drill bit.
